(19) United States
(12) Patent Application Publication
(10) Pub. No.: US 2009/0171493 A1
(43) Pub. Date: Jul. 2, 2009

(54) SYSTEM AND METHOD FOR PERFORMANCE BASED PRODUCTION SCHEDULING AND DISPATCHING

(76) Inventors: Nirmal Govind, Chandler, AZ (US); Nital S. Patel, Mesa, AZ (US); Nitin A Shah, Albuquerque, NM (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/968,140

(22) Filed: Dec. 31, 2007

(51) Int. Cl. G05B 17/02

(52) U.S. Cl. 700/103

(57) ABSTRACT

Execution control systems for optimizing the efficiency of manufacturing processes are described in this application. For example, an execution management system may optimize IC processes and scheduling by analyzing a number of desired metrics along with system constraints, such as tool availability, tool reliability, etc, along with information from conventional processing tools such as APC and SPC. The optimized processing schedule may then be implemented in real-time and updated with new process requests and current information relating to tools and other metrics, thereby reducing human interaction and inefficiency. Other embodiments are also described in this application.

### FIELD

This application relates generally to process and operational management in manufacturing processes. In particular, this application relates to improved correlation of all metrics and processes involved in manufacturing to reduce inefficiencies.

### BACKGROUND

Several problems exist when trying to optimize efficiency in manufacturing processes. For example, in semiconductor, or integrated circuit (IC), production, the conventional approach consists of several disconnected systems such as recipe management system, automated lot qualification system, Advanced Process Control (APC), Statistical Process Control (SPC), performance feedback system, etc. that provide the users tools for configuring parameters of the various processes involved in IC production. In manufacturing, focusing on traditional metrics such as throughput and cycle time alone can lead to low quality and low net product output (yield) due to complexities of some production processes and error compounding due to the difficulty in observing errors in some products. Focusing on other metrics, such as yield and risk alone can lead to inefficient output and capital loss with machines sitting idle. Only considering one or the other set of metrics can result in poor overall performance of the factory. In conventional processing, the execution of each of the various stages and monitoring of the various metrics is managed by technicians of varying skill levels. Due to human involvement, the performance of the process metrics can be inconsistent, causing inefficiencies in processing time and energy spent. Additionally, misprocessing errors and risk due to human intervention exist in current IC processing due to variation in operational execution.

### BRIEF DESCRIPTION OF THE DRAWINGS

The following description can be better understood in light of Figures, in which:

FIG. 1 is a schematic illustration of an exemplary embodiment; and

FIG. 2 is a schematic illustration of an exemplary embodiment.

Together with the following description, the Figures demonstrate and explain the principles of the apparatus and methods described herein.

### DETAILED DESCRIPTION

The following description supplies specific details in order to provide a thorough understanding. Nevertheless, the skilled artisan would understand that the methods, systems and devices described herein can be implemented and used without employing these specific details. For example, while embodiments of the devices, systems, and associated methods described below focus on IC production, embodiments of these devices, systems, and associated methods may be used in other manufacturing processes having similar requirements. For example, such embodiments may be used in the manufacturing processes of medical devices, pharmaceuticals, electronic hardware, metal alloys, mechanical devices, etc. Indeed, the devices, systems, and associated methods can be placed into practice by modifying the systems and methods and can be used in conjunction with any apparatus and techniques conventionally used in any number of fields in the manufacturing industry.

Embodiments of execution control systems, including process control systems, and scheduling and/or dispatching processes that may be used in the manufacture of ICs are described. Some embodiments of the execution control system may incorporate process and performance metrics along with the operational considerations to produce better process metrics such as rework rate and yield, in addition to achieving traditional operational objectives such as cycle time and output. The embodiments describe an integrated approach that combines the information relating to the systems and processes used in IC manufacture along with analysis and optimization of the trade offs in the various conflicting objectives to ensure that operational and process performance measures are jointly optimized, resulting in overall improved system and process efficiency. Embodiments of the execution control systems may function in real time, allowing updated job requests, including job queue, real-time tooling information, to automatically update and manage process and tool resourcing and lot and tool-lot scheduling.

Some execution control systems components may accomplish efficient process control by optimization to minimize misprocessing risk and improve process metrics such as yield by incorporating several process-related performance measures in addition to complex processing constraints in scheduling/dispatching; optimization to maximize work-in-process (WIP) steering to tools based on yield data, yield (efficiency) improvement by minimizing distortion on wafers by scheduling lots to tools with least distortion while accounting for distortion-based stepper dedication; intelligent scheduling of hot lots to avoid some metrology steps and speed up learning rate for new product introductions; minimization of product risk by incorporating feedback-based batching of lots in scheduling; minimizing tool product-layer qualification expiration using lot prioritization to tools, which yields lower rework rate; comprehension of APC information in scheduling to prevent errors during lot processing—existence of APC partitions and checks for process out-of-control; incorporation of SPC and defect data as well as preventative maintenance (PM) data into scheduling/dispatching; and load balancing of tools to reduce product risk and minimize cycle time simultaneously.

The execution control systems may include components to implement the process efficiency, such as a scheduling system based on mathematical optimization and integrated with a real-time dispatcher, an optimization solver to solve the scheduling optimization and trade off conflicting objectives, a mechanism to incorporate tool-level, lot-level, and lot-tool-level guidance to scheduling/dispatching, including integration of Qualification Tracking (recipe management system, automated lot qualification system), APC, SPC, PM, test wafer and monitor lot systems with scheduling and dispatching system, and model constraints that specify the physical limitations of the manufacturing process. Test Wafer and Monitor may be wafers to measure and correct tool performance and health indicators. The execution control systems may also include a scheduler for implementation of the optimized schedule by the other components of the execution control systems. The model constraints may include tool availability, tool productivity, tool operation qualifications, raw material status, rework dedication, tool run rates, risk limits, etc.

Currently, some production processes and efficiency performance is done by manually managing the WIP via Special Instruction Flags (SIF), e.g., non-standard, experiment flags, and manual intervention flags, which adversely affect the operational metrics such as cycle time and throughput. This approach requires significant human intervention and can be sub-optimal for the factory. Additionally, the current approach consists of a plethora of disconnected systems such as recipe management system, automated lot qualification system, APC, SPC, performance feedback system, etc. that provide the users a means of configuring parameters for the various processes. An integrated approach that combines the information in these systems and trades off the various conflicting objectives can ensure that operational and process performance measures are jointly optimized.

Thus, in the conventional systems since the execution of the various disconnected systems and processes is managed by personnel of varying skill levels, the performance of the process and operational metrics can be inconsistent. An automated integrated approach to scheduling and dispatching that takes the process performance measures into account will result in more consistent execution and hence more consistent process performance metrics.

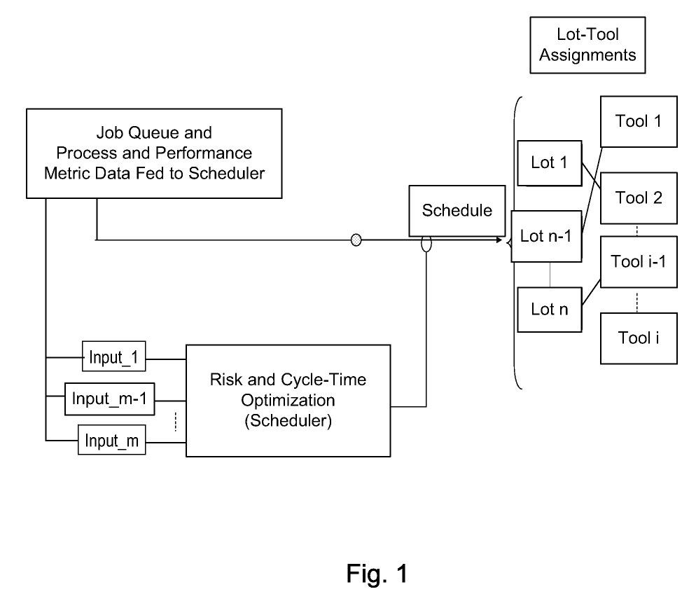

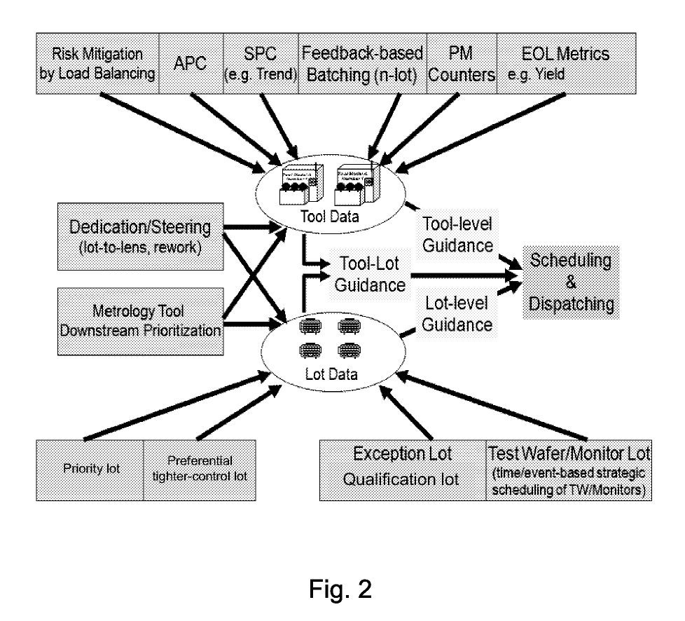

FIG. 1 depicts a high-level schematic of some execution control systems embodiments. Multiple process-related inputs may be taken in by the scheduling optimizer, which may evaluate trade-offs of conflicting objectives such as process risk, cycle time, and throughput to produce a lot-to-tool assignment that is optimal, while comprehending complex constraints, in addition to any of the embodiments of execution control systems, processes or evaluation described herein. FIG. 2 depicts various process-related elements and methodologies for incorporating the elements and methodologies into scheduling and dispatching as tool-level, lot-level or lot-tool guidance.

Each of the various guidance elements may include information related to several process and methodology considerations. For example, tool-level guidance may include load balancing, APC, SPC, feedback-based batching, PM counters, end-of-line metrics, etc. Similarly, lot-level guidance may include hot (priority) lot, preferential tighter-control lot, exception lot and qualification lot minimization, test wafer and monitor scheduling, etc. Lot-tool-level guidance may include dedication, steering, etc. Each of the guidance elements listed above is described below.

In some embodiments, load balancing may function to reduce cycle time. From a process perspective, balancing the load (WIP) across tools also helps reduce risk in quality due to lopsided processing of WIP on a tool, which could result in scrap of large number of wafers in case an issue is found on a tool that has run a large quantity of product wafers. The scheduling system, as described above, may have an objective function component for balancing the workload across the tools.

Similarly, technology, product, operation, and/or tool health indicators related to APC may be input to the scheduling optimizer which indicates the current status of the partition and the performance loss factor (how much performance improvement could be expected by running more material). Doing so may prevent predictable lot aborts, and provide for preferential tool selection for better yield performance. SPC data (e.g. particles, critical dimension, registration measurements) may be used to make tool allocation decisions and further improve preferential tighter-control material performance. Stability of SPC charts for process data may be used to determine optimal tool allocation for each process of several processes taking availability, demand, and other parameters into account. SPC data may be used to run WIP preferentially on tools with better SPC performance data, and skip metrology for some lots such as hot lots and new product introductions without yielding at-risk material.

Feedback-based batching may be used to limit risks for quality excursions at an operation, WIP cascade size may be managed based on layer or operation capability, and in-line metrology feedback may be received. Feedback-based batching may be implemented in embodiments of the execution control systems by using the scheduler to meter WIP based on operation health and metrology feedback data. WIP may be metered through receipt of metrology data to provide productivity and quality improvements. Additionally, PM counters may be used to ensure that sensitive and preferential tighter-control material is not run just after a PM (process may be still stabilizing) or too much into the PM cycle (puts the material at risk due to greater risk of equipment issues). PM counters may be implemented as input to the scheduler to screen out tools that don't fit the risk profile for specific products.

Inline and end-of-line metrics may be used to obtain better yield and higher volume of higher yield product. Information may be fed back from any point in the manufacturing process to critical steps such as lithography, etch, and implant, for example in IC manufacturing, to direct execution earlier in the process. The scheduling optimization's objective function contains components to ensure execution earlier on in the manufacturing process aids performance metrics downstream.

In lot-level guidance, hot lot may be used to obtain faster learning rates and hence such lots can be run on tools that are performing better from a process perspective. Implementation in embodiments of the execution control systems may include a scheduler explicitly tracking performance of each tool (in terms of defects, APC, PM status, etc.) and assign hot lots to only a subset of the tools qualified for the lot that meet certain performance criteria (e.g. number of defects below a threshold, up-from-PM threshold has been met, etc.). Preferential tighter-control lot may be chosen for certain lots to meet end of line performance. Preferential tighter-control lot guidance requires specific lots to be run on specific tools at certain operations. As such, the scheduler may be configured to include preferential consideration in the optimization calculations to determine best overall solution.

Qualification lots minimization may be run due to litho tools being qualified for certain product-operation combinations. This qualification of the tool-product-operation expires after a certain period of inactivity. The scheduler may be employed to have an objective function to minimize the need for qualification lots and hence reducing rework. Test wafer and monitor scheduling may be used to schedule, batch, and assign test wafers and monitors along with production WIP using minimal or no human intervention. Automated scheduling may provide productivity improvement and meets scheduling goals for test wafers and monitors.

Tool-lot-level guidance such as dedication and steering may include lot-to-lens (or distortion-based) dedication and rework-lot dedication in lithography, for example in IC manufacturing, done to match lots to tools based on where the lot was run previously. Effectively, these dedications may steer a lot to one tool or a set of tools to improve the registration and ultimately yield. This may be done in at least two ways, such as placing constraints limiting the set of qualified tools for a lot to only the specified dedicated tool or tools, and ensuring that the objective function contains a component to maximize the preferential allocation of WIP to tools that have least distortion.

Some advantages of embodiments of the execution control systems may include allowing for incorporation of process-related considerations in the scheduling and dispatching system and incorporation of process metrics into the objectives and constraints in the scheduling optimization to produce an optimal solution for the given problem. Similarly, embodiments of the execution control systems do not require human intervention to determine the decision to be made, thereby mitigating risk due to human error and reduces inconsistency between operators. Another advantage may be to reduce exception management by engineers and technicians, because the automation may reduce the need for SIFs and holds. Similarly, the execution control systems described herein may integrate seamlessly with several existing process-related systems such as APC and SPC to obtain all the required information to make decisions.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

1. An execution control system, comprising:
a scheduling system configured to mathematically optimize one or more processes to be performed by the execution control system;
a process control system configured to control processes to be performed by the system;
model constraints information corresponding to physical limitations of the processes to be performed by the system; and
a mechanism configured to implement guidance in process scheduling related to the scheduling system and the model constraints.

2. The system of claim 1, wherein the scheduling system is integrated with a real-time dispatcher.

3. The system of claim 1, wherein the optimization solver includes optimization based at least in part on comparing interactions between at least two process objectives, wherein increased efficiency of one process objective is related to decreased efficiency in another process objective.

4. The system of claim 1, wherein the guidance related to the scheduling system is one or more of tool-level, lot-level, and lot-tool-level guidance.

5. The system of claim 4, wherein the tool-level guidance includes instructions related to at least one of load balancing, APC, SPC, feedback-based batching, preventative maintenance counters, and end-of-line metrics.

6. The system of claim 4, wherein the lot-level guidance includes instructions related to at least one of priority lot, preferential tighter-control lot, qualification lot minimization, and test wafer and monitor scheduling.

7. The system of claim 4, wherein the tool-lot-level guidance includes instructions related to at least one of dedication and steering.

8. A method of controlling manufacturing processes, including:
mathematically optimizing each of a plurality of processes to be performed;
providing model constraints information corresponding to physical limitations of processes to be controlled; and
developing guidance configured to increase efficiency by scheduling the plurality of processes based on the mathematically optimizing and the model constraints information;
implementing the guidance in process scheduling of the plurality of processes to be performed.

9. The method of claim 8, wherein the mathematically optimizing is performed by a scheduler.

10. The method of claim 8, wherein the process scheduling is real-time scheduling.

11. The method of claim 8, wherein the mathematically optimizing includes optimization based at least in part on comparing interactions between at least two process objectives, wherein increased efficiency of one process objective is related to decreased efficiency in another process objective.

12. The method of claim 8, the system of claim 1, wherein the guidance configured to increase efficiency is one or more of tool-level, lot-level, and lot-tool-level guidance.

13. The system of claim 12, wherein the tool-level guidance includes instructions related to at least one of load balancing, APC, SPC, feedback-based batching, preventative maintenance counters, and end-of-line metrics.

14. The system of claim 12, wherein the lot-level guidance includes instructions related to at least one of hot lot, preferential tighter-control lot, send-ahead lot minimization, and test wafer and monitor scheduling.

15. The system of claim 12, wherein the tool-lot-level guidance includes instructions related to at least one of dedication and steering.
